(19) United States
(12) Patent Application Publication
(10) Pub. No.: US 2006/0151371 A1
(43) Pub. Date: Jul. 13, 2006

(54) Oli filter assembly

(76) Inventors: Keith R. Weinberger, Randolph, NJ (US); Alan Johnson, Attelboro, MA (US); Adrian Jefferies, Berks (GB); Kevin Smith, Essex (GB); Chris Ryall, Warwickshire (GB); Kent Nicholson, Cambs (GB)

Correspondence Address: MCANDREWS HELD & MALLOY, LTD, 500 WEST MADISON STREET, SUITE 3400, CHICAGO, IL, 60661, US

(21) Appl. No.: 11/033,341

(22) Filed: Jan. 11, 2005

(51) Int. Cl. B01D 35/30

(52) U.S. Cl. 210/232

(57) ABSTRACT

Embodiments of the present invention provide an oil filter system that is quick and easy to connect and disconnect from an engine. In general, embodiments of the present invention provide a system and method of quickly and efficiently changing an oil filter without using a tool.

### BACKGROUND OF THE INVENTION

Embodiments of the present invention generally relate to an oil filter assembly, and more particularly to an oil filter assembly that is configured to be quickly and easily changed.

A conventional oil filter assembly for an internal combustion engine typically includes a threaded end, which is rotated, twisted, or spun, onto a corresponding mounting structure of the engine. Once the assembly is mounted onto the engine, oil is circulated through the engine for filtering. Unfiltered oil from the engine is passed through a filtering media, such as a pleated paper cylinder, of the assembly. As the unfiltered oil passes through the filtering media, impurities contained within the oil are retained by the filter. Filtered oil is then passed back into the engine. Eventually, an oil filter assembly, or at least the filtering media within the assembly, needs to be replaced due to the fact that it becomes clogged with numerous impurities, thereby diminishing its filtering ability.

Typical filters may be one-, two-, or three-part filters, depending on whether the parts of the filter can be disconnected from one another. In a one-part filter assembly, the filtration media is contained within a housing, and the entire filter assembly is screwed onto and off of an engine. When the filter medium is clogged, the entire filter assembly must be replaced.

A typical two-part filter assembly includes a casing and a base that threadably engage one another to form a housing around the filtration media. The base is affixed to a mounting structure of an engine. For example, the base may be screwed onto a mounting stud of the engine. The casing, including the filtration media, may be removably secured, such as through threadable engagement, to the base, without removing the base from the engine. When the filtering media needs to be replaced, the casing is removed from the base, and a new casing is secured to the base.

A typical three-part filter assembly is similar to the two part filter assembly, except that the filtration media is separable from the rest of the assembly. As such, only the filtration media needs to be replaced, and the rest of the assembly may be reused with a new filtration medium.

In order to change the filtration media in typical filters, one component is typically unscrewed from another component. The threads of such threadable interfaces are prone to sticking, which can pose difficulties in removing an oil filter from the engine (for a one-part filter assembly), or the casing from the base (for a two- or three-part filter assembly). Often, a specialized tool, such as an oil filter wrench, is required to remove the filter or casing from the engine. In many vehicles, however, the oil filter assembly is located at a position that is difficult to access. Thus, using a tool with some oil filters may be difficult. Even if a tool were not required, manually unscrewing, or otherwise rotating the oil filter may also not be easy due to limited space proximate the engine and oil filter assembly.

Thus, a need exists for an oil filter assembly that is quick and easy to connect and disconnect from an engine. That is, a need exists for a system and method of quickly and efficiently changing an oil filter.

### SUMMARY OF THE INVENTION

Embodiments of the present invention provide a fluid filter system including a base or adapter having an unfiltered fluid inlet and a filtered fluid outlet, and a casing configured to be removably connected to the base, wherein a fluid filter chamber is defined within at least one of the casing and the base. In general, the casing connects and disconnects from the base in a linear manner such that the casing is not rotated with respect to the base. Further, no tool is needed to connect the casing to the base, or disconnect it from the base.

Certain embodiments of the present invention provide a ridge formed on an exterior surface of either the base or casing, and a protuberance extending outwardly from an interior surface of the other of the base or the casing. The protuberance is configured to be securely retained by the ridge so that the casing is securely connected to the base. The protuberance is movably retained within a channel, and may be moved between a connection position, in which the protuberance is fully extended, and a disconnection position, in which the protuberance recedes into the channel.

A disconnection sleeve may be positioned over either the base or casing. The disconnection sleeve is operatively connected to the protuberance, and is actuated to move the protuberance between the connection and disconnection positions.

Embodiments of the present invention may also include a fluid inlet valve configured to allow fluid to enter the casing when it is connected to the base, and prevent fluid from leaking from the casing when it is disconnected from the base. The fluid inlet valve may include a first end fixed within the casing and a second end that is configured to move to allow circulating fluid to enter the casing.

Embodiments of the present invention may also include a fluid outlet valve including a mounting post integrally connected with sloped lateral portions that cover fluid passages. The fluid outlet valve is configured to prevent fluid from leaking from the casing when the casing is disconnected from the base.

The fluid outlet valve may optionally include two flaps disposed within a fluid passage. Each of the flaps has a fixed end and a free end. The free ends of the flaps connect at distal ends to form a sealing apex that prevent fluid from leaking when the casing is disconnected from the base. When the casing is connected to the base, circulating fluid forces the flaps apart to allow fluid to pass through the valve.

Certain embodiments of the present invention also provide a spring lock outwardly extending from a lateral wall of either the base or casing. The spring lock includes a main body having a ramped surface. The other of the base or casing, which does not include the spring lock, includes a lock retaining member, such as a slot or compartment that conforms to the shape of the spring lock. The spring lock is configured to be securely retained within the lock retaining member in order to securely connect the casing to the base.

Certain embodiments of the present invention also provide a fluid filter system, including a trapezoidal locking member extending outwardly from either the base or the casing, and a lock receptacle extending inwardly from the other of the base or casing. The lock receptacle is configured to securely retain the trapezoidal locking member in order to securely connect the casing to the base.

The lock receptacle includes first and second teeth separated by a gap. In a fully connected position, the trapezoidal locking member is lodged within the gap, thereby providing a secure connection between the casing and the base. The lock receptacle may also include a ramped base, wherein the trapezoidal locking member is configured to slide over the ramped base when the casing is being connected to the base. A lock boundary extending inwardly from either the base or casing, assists in aligning the trapezoidal locking member when the casing is connected to, and disconnected from, the base.

### BRIEF DESCRIPTION OF SEVERAL VIEWS OF THE DRAWINGS

FIG. 1 illustrates an isometric exploded view of an oil filter assembly according to an embodiment of the present invention.

FIG. 1A illustrates an isometric cross-sectional view of an oil filter assembly in which a casing is disconnected from a base according to an embodiment of the present invention.

FIG. 1B illustrates an isometric view of an oil filter assembly according to an embodiment of the present invention.

FIG. 2 illustrates a top isometric view of a base of an oil filter assembly according to an embodiment of the present invention.

FIG. 3 illustrates a front view of an oil filter assembly according to an embodiment of the present invention.

FIG. 4 illustrates a simplified view of interior walls of a casing and base of a disconnected oil filter assembly according to an embodiment of the present invention.

FIG. 5 illustrates a simplified partial view of a locking member of a casing within a base through connection and disconnection stages according to an embodiment of the present invention.

FIG. 6 illustrates a transverse cross-sectional view of an oil filter assembly according to an embodiment of the present invention.

FIG. 7 illustrates a transverse cross-sectional view of an oil filter assembly according to an embodiment of the present invention.

The foregoing summary, as well as the following detailed description of certain embodiments of the present invention, will be better understood when read in conjunction with the appended drawings. For the purpose of illustrating the invention, there is shown in the drawings, certain embodiments. It should be understood, however, that the present invention is not limited to the arrangements and instrumentalities shown in the attached drawings.

### DETAILED DESCRIPTION OF THE INVENTION

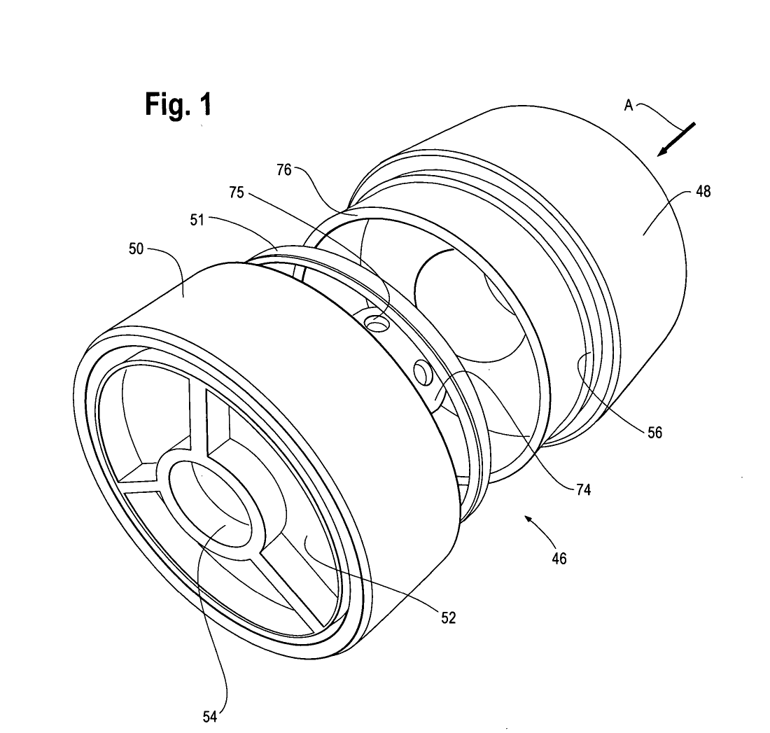

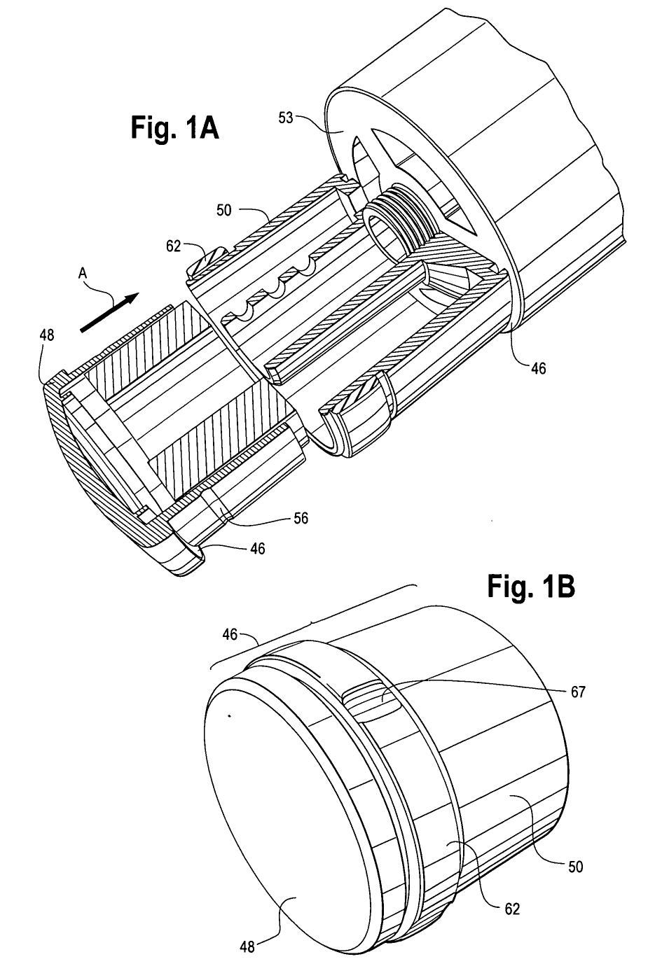

FIG. 1 illustrates an isometric view of an oil filter assembly 46 according to an embodiment of the present invention. The oil filter assembly 46 includes a casing 48 that is configured to be secured to a base 50, having unfiltered oil inlets 52 and a filtered oil outlet 54. The casing 48 is secured to the base 50 by urging the casing 48 toward the base 50 in a linear fashion denoted by arrow A. The casing 48 of the oil filter assembly 46 is not screwed or otherwise rotated in order to secure it to the base 50.

Sealing members, such as gasket 51, are also positioned about a mating interface of the casing 48 and the base 50 in order to prevent fluid leaks. The sealing members, such as the gasket 51, may be integrally formed with the casing 48 and/or base 50. The casing 48 and the base 50 may also include additional sealing members, O-rings, gaskets and the like, that form sealing connections when the casing 48 is mated with the base 50 so that fluid does not leak at connection interfaces.

The base 50 may be a portion of an engine. For example, the base 50 may be a mounting stud of an engine. Alternatively, the base 50 may be an adapter that mounts on the mounting stud of the engine. For example, the base 50 may threadably, snapably, or latchably engage the mounting stud.

The oil filter assembly 46 filters oil in a known manner. That is, unfiltered oil enters an internal filtering chamber through the inlets 52 formed through the base 50, and passes through a filtering medium (not shown) that is positioned about a filter support member 74. The filtering medium filters the unfiltered oil. The filtered oil then passes through passages 75 formed through the support member 74, and out of the base 50 through the oil outlet 54.

The casing 48 includes a channel, indentation, or ridge 56 formed around an outer circumference of the casing 48. The ridge 56 may contiguously extend around the casing 48, as shown in FIG. 1. Optionally, instead of the ridge 56, the casing 48 may include a plurality of notches, channels, divots, indentations, or the like formed at distinct points around the casing 48. The ridge 56 is configured to cooperate with protuberances formed within the base 50 to secure the casing 48 to the base 50.

As shown in FIG. 1, the casing 48, base 50, and filter support member 74 are shown as three separate components. The filter support member 74, however, may be integrally formed with either the casing 48 or the base 50. Further, the filter support member 74 and the oil filtering chamber may be contained entirely within the casing 48.

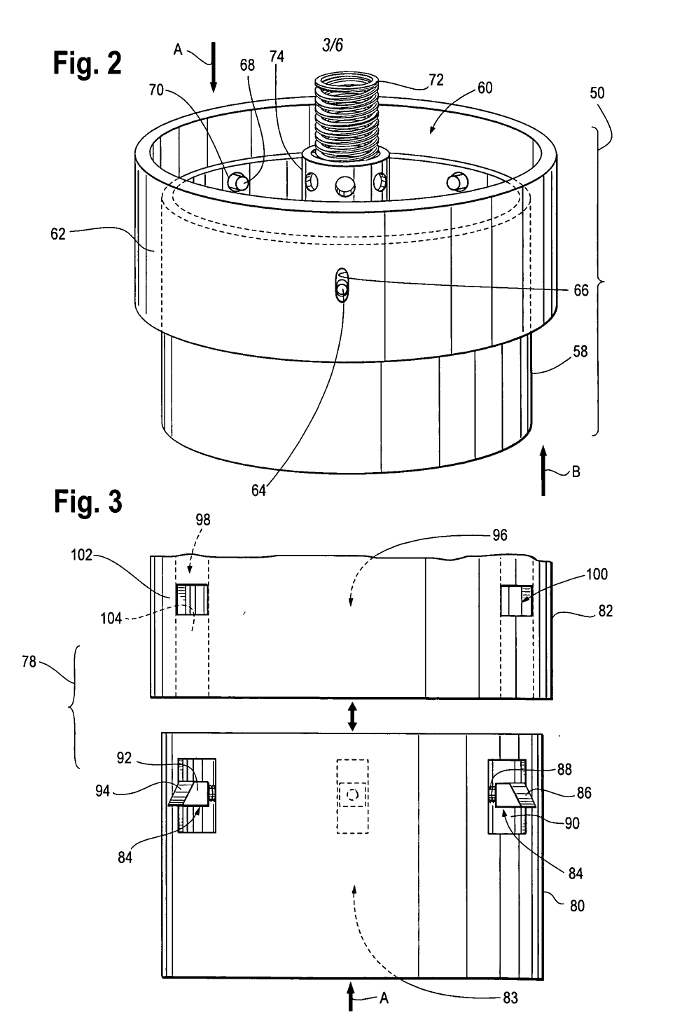

FIG. 2 illustrates a top isometric view of the base 50 shown in FIG. 1. The base 50 includes a main cylindrical wall 58 defining a filtering chamber 60. A spring-biased disconnection sleeve 62 is disposed over the wall 58, and is held in place by at least one retaining post 64 that extends into the wall 58, and is positioned within a channel 66 of the sleeve 62. The sleeve 62 is operatively connected to protuberances 68 that extend into the filter chamber through retaining channels 70 formed through the wall 58. The protuberances 68 may be spring-biased. Optionally, the protuberances 68 may be slidably, or otherwise moveably retained within the channels 70 such that the protuberances 68 may be forced back into the channels 70. The protuberances 68 may be balls that conform to the shape of the ridge 56 (shown in FIG. 2) of the casing 48 (also shown in FIG. 2).

The base 50 also includes a spring 72 that may be retained within the filter support member 74. The spring 72 may assist in ejecting the casing 48 from the base 50 during disconnection.

When the sleeve 62 is in a connection position, the sleeve 62 exerts an inwardly-directed force into the protuberances 68 such that the protuberances 68 are forced toward, and fully extend into, the filtering chamber 60. When the sleeve 62 is urged in the direction of arrow A, the sleeve 62 loses full contact with the protuberances 68, thereby exerting less, or no, force into the protuberances 68. Optionally, instead of losing full contact with the protuberances 68, the sleeve 62 may act to shift the protuberances 68 in a direction that causes the protuberances 68 to recede into the channels 70. As such, the protuberances 68 recede back into the channels 70. Thus, the protuberances 68 no longer fully extend into the filtering chamber 60. As the sleeve 62 moves to its original position in the direction of arrow B, either by a user urging it in that direction, or by a spring force returning it to its original position, the sleeve 62 fully engages the protuberances 68, thereby forcing the protuberances 68 back into a position in which the protuberances 68 fully extend into the filtering chamber 60.

FIG. 1A illustrates an isometric cross-sectional view of the oil filter assembly 46 in which the casing 48 is disconnected from the base 50. FIG. 1B illustrates an isometric view of the oil filter assembly 46 in which the casing 48 is securely connected to the base 50.

Referring to FIGS. 1 and 1A, 1B, and 2, the base 50 is removably secured to a mounting stud 53 (shown, e.g., in FIG. 1A) of an engine (not shown). The base 50 may, for example, be threadably, latchably, snapably or otherwise removably secured to the mounting stud 53. Alternatively, the base 50 may be integrally formed with the mounting stud 53.

The casing 48 is urged in the direction of arrow A in order to connect it to the base 50. The casing 48 of the oil filter assembly 46 is not screwed or threaded onto the base 50. Instead, the casing 48 is urged into the base 50 in a linear direction denoted by arrow A, and is removably secured to the base 50.

In order to connect the casing 48 to the base 50, the casing 48 is urged into the base in the direction of arrow A. At the same time, the sleeve 62 may also be urged in the direction of arrow A in order to retract the protuberances 68 from their fully extended positions, as described above, so that the casing 48 may slide into the base 50. Optionally, the oil filter assembly 46 may be configured so that the mating end 76 of the casing 48 slides over the protuberances 68, thereby pushing them into the channels 70, and allowing the casing 48 to further slide into the base 50 in the direction of arrow A.

The casing 48 continues to slide into the base 50 until the ridge 56 encounters the protuberances 68. At this point, the force exerted on the protuberances 68 by the sleeve 62 causes the protuberances 68 to snap, spring, or otherwise move into the ridge 56. As such, the protuberances 68 are retained by the ridge 56, thereby securely connecting the casing 48 to the base 50.

In order to disconnect the casing 48 from the base 50, the sleeve 62 is pushed in the direction of arrow A. Consequently, the protuberances 68 recede into the channels 70, as described above, and lose contact with the ridge 56. As the protuberances 68 lose contact with the ridge 56, the force exerted by the spring 72 into the casing 48 ejects the casing 48 from the base 50.

While the embodiment shown in FIGS. 1, 1A, 1B, and 2 shows a base 50 having the protuberances 68 and the casing 48 having the ridge 56, the base 50 may alternatively include the ridge 56, while the casing 48 includes the protuberances 68. Further, the casing 48 may optionally include the sleeve 62. Also, alternatively, the oil filter assembly 46 may not include the sleeve 62. Instead, various other mechanisms may be used to disengage the protuberances 68. For example, buttons on the side of the base wall may be operatively connected to each protuberance 68.

Further, the sleeve 62 may include finger-engaging indentations, or surfaces 67 (as shown in FIG. 1B) that allow a user to firmly grasp the sleeve. The finger-engaging surfaces 67 may be operatively connected to the protuberances 68 (as shown, for example, in FIG. 2).

FIG. 3 illustrates a front view of an oil filter assembly 78, which includes a casing 80 that is configured to securely connect to a base 82. The casing 80 includes a filtering chamber 83 and sealed locking members 84, which include a lock 86 operatively connected to a spring 88 within a fluid-tight chamber 90. The lock 86 includes a main body 92 having a ramped surface 94. The lock 86 is configured to be securely retained within a slot, channel, opening, or other such lock-securing feature or structure formed within the base 82.

The base 82 includes a fluid passage area 96 and lock paths 98, which may be sealed from the fluid passage area 96. Lock-securing features, such as slots 100 are formed through outer walls 102 of the base 82.

In order to connect the casing 80 to the base 82, the casing 80 is urged into the base 82 in the direction of arrow A. As the casing 80 is urged into the base 82, the ramped surfaces 94 of the locks 86 slide over inner surfaces 104 of the outer walls 102. When the locks 86 reach the slots 100, the forces exerted on the locks 86 by the springs 88 urge the locks into the slots 100, thereby securing the locks 86 within the slots 100. Thus, the casing 80 is secured to the base 82 by the slots 100 securely retaining the locks 86.

In order to disconnect the casing 80 from the base 82, an inwardly-directed force is exerted upon each of the locks 86 so that the locks 86 no longer extend through the slots 100. The casing 80 may then be slid away from the base 82. Optionally, the base 82 may include a spring, as discussed above with respect to FIG. 3, that assists in ejecting the casing 80 from the base 82.

The casing 80 may alternatively be disconnected from the base 82 by urging the casing 82 in the direction of arrow A so that the ramped surfaces 94 of the locks 86 slide over the upper boundaries of the slots 100. The casing 80 is further urged in this direction until the locks 86 slide completely past the slots 100. Once the locks 86 are removed from the slots 100, the casing 80 may be rotated (so that the locks 86 will no loner be aligned with the slots 100, and then the casing 80 may be slid away from the base 82.

Alternatively, the base 82 may include the locking members 84 while the casing 80 includes the slots 100. Also, while only two locking members 84 and corresponding slots 100 are shown in FIG. 3, the oil filter assembly 78 may include more or less than those shown.

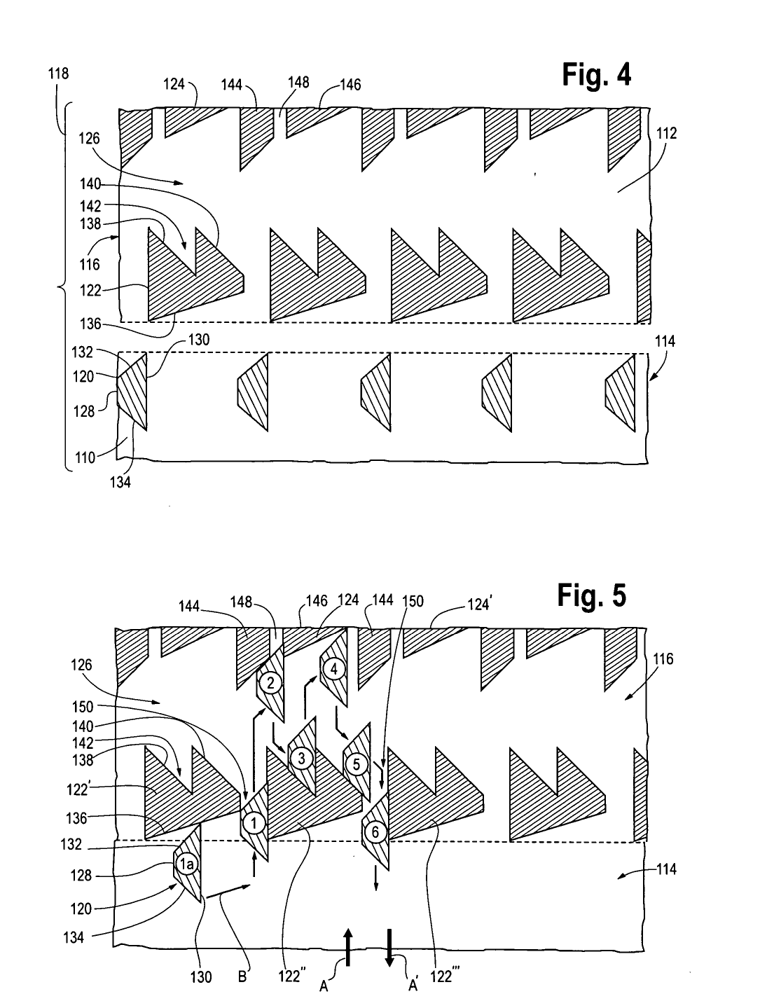

FIG. 4 illustrates a simplified partial view of interior walls 110, 112 of a casing and base 114, 116, respectively, of a disconnected oil filter assembly 118 according to an embodiment of the present invention. The interior wall 110 of the casing 114 includes a plurality of locking members 120, while the interior wall 112 of the base 116 includes a plurality of lock receptacles 122 and lock boundaries 124 separated by a space 126.

The locking members 120 extend inwardly from the interior wall 110 and are shaped as trapezoids. Each locking member 120 includes a vertical short side 128 connected to a vertical long side 130 through an upper ramped surface 132 and a lower ramped surface 134. The short and long sides 128 and 130 are parallel with one another. The orientation of the upper and lower ramped surfaces 132 and 134 may be 90 degrees out of phase with one another.

The lock receptacles 122 and lock boundaries 124 extend inwardly from the interior wall 112. Each lock receptacle 122 includes a ramped base 136 and two teeth 138 and 140 separated by a slanted gap 142. Each lock boundary 124 includes a slanted column 144 and a shorter ramp 146 separated by a gap 148.

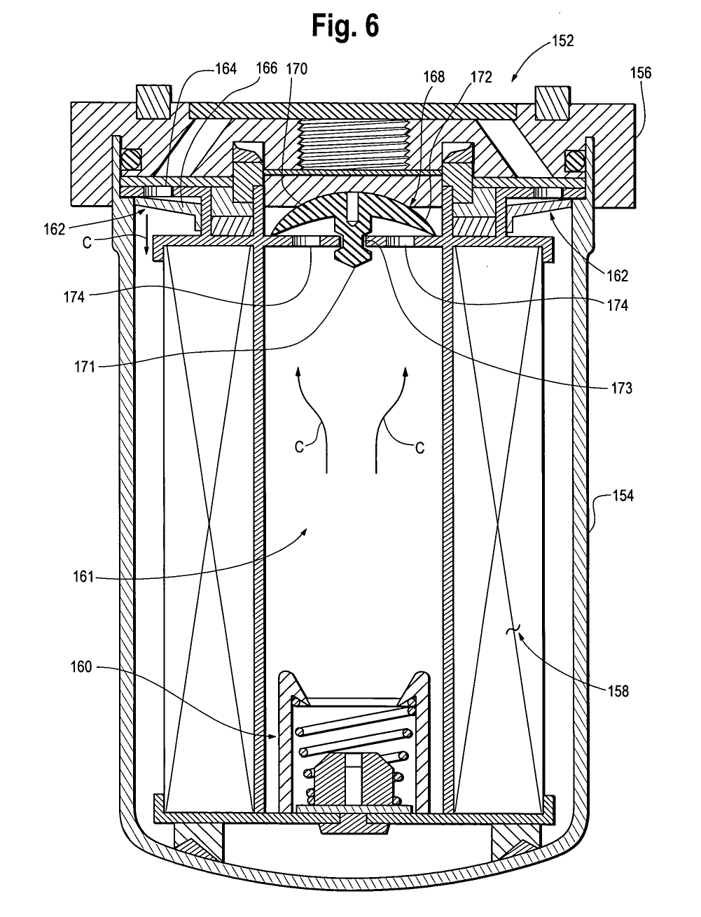

In order to connect the casing 114 to the base 116, the casing 114 is urged into the base 116 in the direction of arrow A, as shown in FIG. 5. Once the casing 114 engages the base 116, the casing 114 is rotated with respect to the base 116 in order to securely retain the lock members 120 within the lock receptacles 122, as discussed below with respect to FIG. 6.

FIG. 5 illustrates a simplified view of the locking member 120 shown in FIG. 4 through connection and disconnection stages. For the sake of simplicity, only one locking member 120 is shown moving through connection and disconnection paths.

The casing 114 is urged into the base 116 in the direction of arrow A, until the upper ramped surface 132 of the locking member 120 engages the ramped base 136 of a first lock receptacle 122′. The position of the locking member 120 is denoted by “1a” at this point.

As the casing 114 continues to be urged in the direction of arrow A, the locking member 120 slides over the ramped base 136 in the direction of arrow B until it encounters a channel 150 that separates the lock receptacles 122′ and 122″, at position “1.” The channel 150 is configured to be slightly wider than the locking member 120, thereby allowing the locking member 120 to pass therethrough.

As the casing 114 continues to be urged in the direction of arrow A, the locking member 120 moves through the channel 150 and through the space 126 until its progress is impeded by the slanted column 144. The locking member 120 than slides over the slanted column 144 into the gap 148 until its movement in that direction is halted by the ramp 146 at position “2.”

Once the movement of the casing 114 is halted by the locking member 120 engaging the ramp 146 at position “2,” the casing 114 is precluded from moving further in the direction of arrow A. Instead, the casing 114 may be urged in the direction of A′ or simply be allowed to drop back in such a direction. As the casing 114 moves in the direction of A′, the lower ramped surface 134 of the locking member 120 engages the first tooth 138 of the locking receptacle 122. The locking member 120 then slides down the tooth 138 into the gap 142 until it is lodged between the first tooth 138 and the second tooth 140 at position “3,” thereby securing the casing 114 to the base 116.

In order to disconnect the casing 114 from the base 116, the casing 114 is urged in the direction of arrow A, so that the locking member 120 is dislodged from the gap 142 between the teeth 138 and 140. The locking member 120 continues to be moved in the direction of arrow A, until it encounters the ramped surface of the ramp 146. The locking member 120 slides over the ramp 146 until it encounters the slanted column 144 of an adjacent lock boundary 124′ at position “4.” Movement of the casing 114 in the direction of arrow A at this point will be stopped by the lock boundary 124′. The casing 114 is then moved in the direction of arrow A′, and the locking member 120 passes through the space 126 in that direction until it encounters the second tooth 140 at position “5.” The locking member 120 then slides over the tooth 140 until it reaches another gap 150, at which point the locking member 120 exits the base 116 at position “6.” As such, the casing 114 may be removed from the base 116.

Alternatively, the base 116 may include the locking members 120, while the casing 114 includes the lock receptacles 122 and lock boundaries 124. Also, the locking members 120, lock receptacles 122 and lock boundaries 124 may assume various other geometric shapes and sizes. For example, the locking members 120 may include rounded edges, while the lock receptacles include rounded cooperating teeth, and the like.

FIG. 6 illustrates a transverse cross-sectional view of an oil filter assembly 152 according to an embodiment of the present invention. The oil filter assembly 152 includes a casing 154 removably connected to a base 156 through systems and methods discussed above with respect to FIGS. 1-5. A filter medium 158 is disposed within the oil filter assembly 152. A bypass valve 160 is also disposed within the casing 154 and is configured to activate at a predetermined pressure.

The oil filter assembly 152 also includes an oil inlet valve 162 positioned over an unfiltered oil inlet 164. The valve 162 may be a check valve or any other such type of device that allows fluid to pass in only direction. The valve 162 may be a flap of material, such as an elastomeric material, that is fixed at one end 166 to the casing 154. As unfiltered oil enters the oil inlet 164, the free end of the valve 162 moves in the direction denoted by arrow C, thereby allowing the unfiltered oil to pass into the filtering chamber 161 of the oil filter assembly 152. The valve 162, however, prevents oil within the filtering chamber 161 from flowing back into the oil inlet 164. Thus, when the casing 154 is disconnected from the base 156, fluid does not drip from oil inlet areas of the casing 154.

The oil filter assembly 152 also includes an oil outlet valve assembly 168, which includes a main body 170 having a mounting post 171 secured within a mounting receptacle 173 of the casing 154. The main body 170 also includes lateral portions 172 that extend from an end of the mounting post 171 that is distally located from the filtering chamber 161. The lateral portions 172 slope downwardly from the mounting post 171 to cover filtered oil outlets 174 located to the sides of the mounting post 171. Oil passing through the oil outlets 174 in the direction of arrows C forces the lateral portions 172 to pivot open about the mounting post 171. The valve assembly 168, however, prevents filtered oil that has passed through the casing 154 from re-entering the casing 154 through the outlets 174. Further, the valve assembly 168 is configured to prevent oil from passing through the casing 154 when oil circulation stops. Thus, when the casing 154 is removed from the base 156, the valve assembly 168 ensures that oil does not leak through the oil outlets 174.

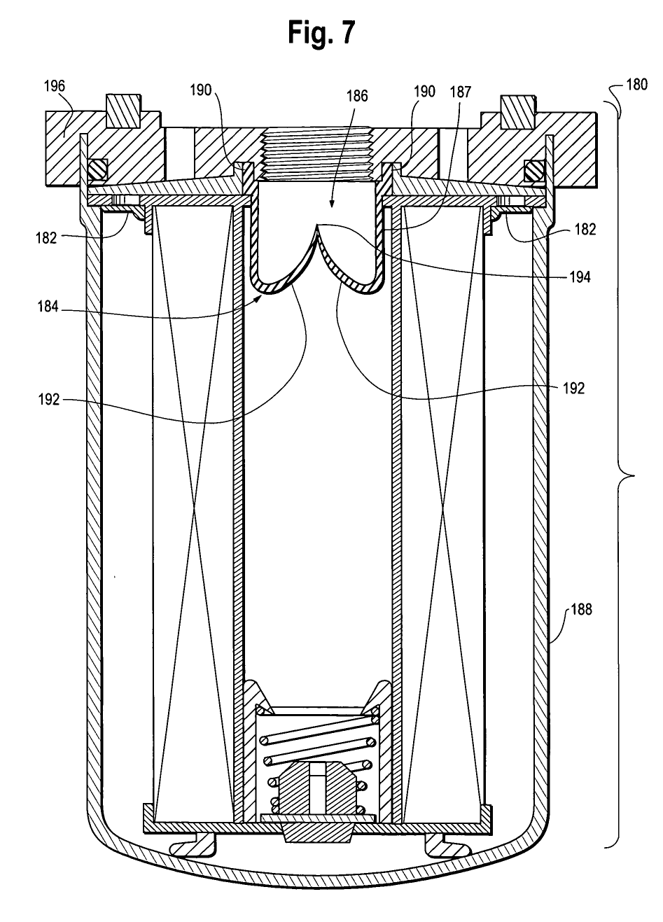

FIG. 7 illustrates a transverse cross-sectional view of an oil filter assembly 180 according to an embodiment of the present invention. The oil filter assembly 180 includes oil inlet valves 182, similar to those described above with respect to FIG. 6, and an oil outlet valve 184 disposed within an oil outlet 186. The oil outlet 186 is a single path for filtered oil egress. The valve 184 resembles a “W” and includes flexible sealing flaps 187 having respective ends 190 secured to the casing 188, and free ends 192 that fold over and form a sealing engagement with one another at a sealing apex 194. The free ends 192 remain in sealing engagement at the sealing apex 194 so long as oil is not circulating through the oil filter assembly 180. As such, the valve 184 ensures that oil does not pass out of the casing 188 when it is disconnected from the base 196. When oil circulates through the connected oil filter assembly 180, the pressure of the circulating oil at the oil outlet 186 forces the free ends 192 of the valve 184 to separate so that filtered oil may pass therethrough, and into an engine. The valve 184 may be used with any of the oil filter assemblies discussed above with respect to FIGS. 1-5.

Embodiments of the present invention may be used to filter oil within an internal combustion engine. In particular, embodiments of the present invention provide an oil filter assembly that is quick and easy to connect and disconnect from an engine. In general, embodiments of the present invention provide a system and method of quickly and efficiently changing an oil filter without using a tool.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiments disclosed, but that the invention will include all embodiments falling within the scope of the appended claims.

1. A fluid filter system, comprising:
a base having an unfiltered fluid inlet and a filtered fluid outlet;
a casing configured to be removably connected to said base, wherein a fluid filter chamber is defined within at least one of said casing and said base;
a ridge formed on an exterior surface of one of said base and said casing; and
a protuberance extending outwardly from an interior surface of the other of said base and said casing, wherein said protuberance is configured to be securely retained by ridge so that said casing is securely connected to said base.

2. The fluid filter system of claim 1, wherein said protuberance is movably retained within a channel, said protuberance being moved between a connection position, in which said protuberance is fully extended, and a disconnection position, in which said protuberance recedes into said channel.

3. The fluid filter system of claim 2, further comprising a disconnection sleeve positioned over one of said base and casing, wherein said disconnection sleeve is operatively connected to said protuberance, and wherein said disconnection sleeve is actuated to move said protuberance between the connection and disconnection positions.

4. The fluid filter system of claim 1, further comprising at least one spring positioned within one of said base and said casing, wherein said spring exerts a force between said base and said casing in order to eject said casing from said base when said casing is disconnected from said base.

5. The fluid filter system of claim 1, further comprising a plurality of protuberances, wherein said casing connects and disconnects from said base in a linear manner.

6. The fluid filter system of claim 1, wherein said casing further comprises a fluid inlet valve configured to allow fluid to enter said casing when said casing is connected to said base and prevent fluid from leaking from said casing when said casing is disconnected from said base, said fluid inlet valve comprising a first end fixed within said casing and a second end that is configured to move to allow circulating fluid to enter said casing.

7. The fluid filter system of claim 1, wherein said casing further comprises a fluid outlet valve comprising a mounting post integrally connected with sloped lateral portions that cover fluid passages, wherein said fluid outlet valve is configured to prevent fluid from leaking from said casing when said casing is disconnected from said base.

8. The fluid filter system of claim 1, wherein said casing further comprises a fluid outlet valve comprising two flaps disposed within a fluid passage, each of said flaps having fixed ends and free ends, said free ends of said flaps forming a sealing apex that prevents fluid from leaking when said casing is disconnected from said base, and wherein circulating fluid forces said flaps apart when said casing is connected to said base.

9. The fluid filter system of claim 1, wherein said base is integrally formed with a mounting stud of an engine.

10. A fluid filter system, comprising:
a base having an unfiltered fluid inlet and a filtered fluid outlet;
a casing configured to be removably connected to said base, wherein a fluid filter chamber is defined within at least one of said casing and said base;
a spring lock outwardly extending from a lateral wall of one of said base and said casing, said spring lock comprising a main body having a ramped surface; and
a lock retaining member formed in the other of said base and said casing, wherein said spring lock is configured to be securely retained within said lock retaining member in order to securely connect said casing to said base.

11. The fluid filter system of claim 10, wherein said lock retaining member is a slot.

12. The fluid filter system of claim 10, further comprising a plurality of spring locks and lock retaining members, wherein no tool is needed for said casing to be connected to, and disconnected from, said base.

13. A fluid filter system, comprising:
a base having an unfiltered fluid inlet and a filtered fluid outlet;
a casing configured to be removably connected to said base, wherein a fluid filter chamber is defined within at least one of said casing and said base;
a locking member extending outwardly from one of said base and said casing; and
a lock receptacle extending inwardly from the other of said base and said casing, wherein said lock receptacle is configured to securely retain said locking member in order to securely connect said casing to said base.

14. The fluid filter system of claim 13, wherein said locking member is a trapezoidal locking member.

15. The fluid filter system of claim 14, wherein said lock receptacle comprises first and second teeth separated by a gap, wherein said trapezoidal locking member is lodged within said gap when said casing is connected to said base.

16. The fluid filter system of claim 15, wherein said lock receptacle further comprises a ramped base, wherein said trapezoidal locking member is configured to slide over said ramped base when said casing is being connected to said base.

17. The fluid filter system of claim 15, further comprising a lock boundary extending inwardly from said opposite one of said base and said casing, said lock boundary comprising a slanted column separated from a ramp, wherein said lock boundary assists in aligning said trapezoidal locking member when said casing is connected to, and disconnected from, said base.

18. The fluid filter system of claim 14, further comprising a plurality of trapezoidal locking members and a plurality of lock receptacles, wherein adjacent lock receptacles are separated from one another by a channel that is configured to allow one of said plurality of trapezoidal locking members to slide therethrough.
